(19) United States
(12) Patent Application Publication
(10) Pub. No.: US 2025/0274628 A1
(43) Pub. Date: Aug. 28, 2025

(54) DYNAMIC DISPLAY OF USER CONTENT

(71) Applicant: Atmosphere.tv, Austin, TX (US)

(72) Inventors: Leo Resig, Austin, TX (US); John Resig, Austin, TX (US); Ryan Skrzypek, Austin, TX (US); Michael Angstadt, Pflugerville, TX (US)

(21) Appl. No.: 18/588,394

(22) Filed: Feb. 27, 2024

(51) Int. Cl. H04N 21/414; H04N 21/2743; H04N 21/431; H04N 21/4545; H04N 21/472; H04N 21/81

(52) U.S. Cl. CPC H04N 21/41415; H04N 21/2743; H04N 21/431; H04N 21/4545; H04N 21/47205; H04N 21/8186

(57) ABSTRACT

Systems and methods are disclosed for implementing a system to dynamically display user content. In certain embodiments, a method may comprise displaying, via a streaming service, an actionable content element at a display of a first public venue, the actionable content element directing a user device to a service for uploading user generated content (UGC). The method may further comprise receiving the UGC at the streaming service, and displaying the UGC at a screen of a selected public venue.

### SUMMARY

In certain embodiments, a method may comprise implementing a system to dynamically display user content, including displaying, via a streaming service, an actionable content element at a display of a first public venue, the actionable content element directing a user device to a service for uploading user generated content (UGC). The method may further comprise receiving the UGC at the streaming service, and displaying the UGC at a screen of a selected public venue.

In certain embodiments, a system may comprise a streaming service configured to dynamically display user content, including: display an actionable content element at a display of a first public venue, the actionable content element directing a user device to a service for uploading user generated content (UGC), receive the UGC at the streaming service, and display the UGC at a screen of a selected public venue.

In certain embodiments, a memory device may store instructions that, when executed, cause a processor to perform a method comprising implementing a system to dynamically display user content, including generating, via a streaming service, a quick response (QR) code that includes venue-specific data identifying a first public venue. The method may further include displaying, via the streaming service, the QR code at a display of the first public venue, the QR code directing a user device to a service for uploading user generated content (UGC), the UGC including at least one of an image file and a video file, receiving the UGC and the venue-specific data at the streaming service, setting a selected public venue to include the first public venue based on receiving the venue-specific data, and displaying the UGC at a screen of the selected public venue.

### BRIEF DESCRIPTION OF THE DRAWINGS

FIG. 1 is a diagram of a system configured to implement a dynamic display of user content, in accordance with certain embodiments of the present disclosure;

FIG. 2 is a diagram of a system configured to implement a dynamic display of user content, in accordance with certain embodiments of the present disclosure;

FIG. 3 depicts a flowchart of an example method for implementing a dynamic display of user content, in accordance with certain embodiments of the present disclosure; and

FIG. 4 is a diagram of a system configured to implement a dynamic display of user content, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

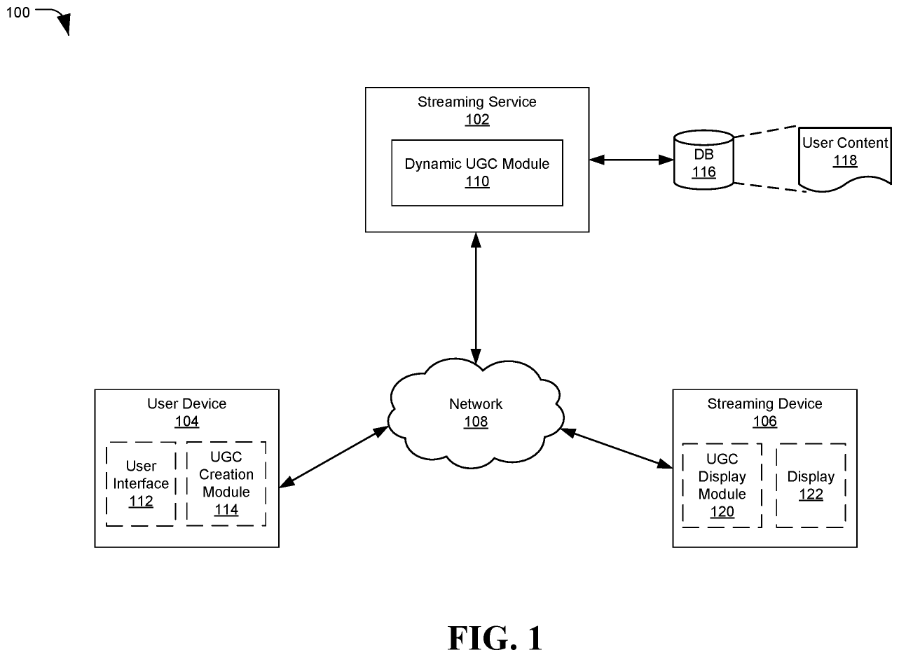

FIG. 1 depicts a diagram of a system 100 configured to implement a dynamic display of user content, in accordance with certain embodiments of the present disclosure. In particular, FIG. 1 depicts an example streaming system 100 that enables users to dynamically share selected content or media at a public venue in near real-time. Users may upload photos, videos, or other media to create personalized “shout-outs” that will then be displayed at a current or selected restaurant, bar, club, sporting event, or other venue. The streaming system 100 may include a streaming service 102, a user device 104, a streaming device 106, and a network 108. Each or any of streaming service 102, user device 104, streaming device 106, and network 108 may be implemented via computers, servers, hardware and software modules, or other system components. Further, streaming service 102 may include or have access to a database (DB) or storage system 116. DB 116 may include one or more data storage devices, data storage mediums, data storage servers, and related data structures, and may store information about streaming service 102, user device 104, streaming device 106, user-generated content (UGC) or user content 118, or other information.

Streaming service 102, sometimes referred to as content display service, may generate, publish, display, or broadcast content to streaming device 106. Some or all of the content, such as video segments or advertisements, may originate from the streaming service 102 itself, or may be obtained or transmitted from one or more other content sources or user device 104. In some embodiments, the streaming service 102 may acquire (e.g., download from, or have uploaded from) content from user device 104 and other content sources, and generate streaming or other visual content in a content feed to send to streaming device 106 over network 108. As an example, streaming service 102 may provide one or more content streams or channels to streaming device 106 to select from, such as sports content, music videos, humorous video clips, news segments, or other content. The content streams may include breaks for advertising, displaying details about the venue in which streaming device 106 is located, or UGC provided from user device 104, allowing individual users to share shout-outs or personal content with audiences at a particular venue.

Accordingly, streaming service 102 may include dynamic UGC module 110. The dynamic UGC module 110 may be configured to provide an interface (such as an application programming interface, API) by which users may provide their UGC to the streaming service 102, and may integrate the UGC into the content stream provided to one or more target streaming devices 106 in selected venues.

The dynamic UGC module 110 may generate venue-specific actionable content, such as custom web links, quick response (QR) codes, or other elements that users may interact with to access the dynamic user content display service. The QR code or other actionable element may be embedded into content displayed at the streaming device(s) 106 associated with a particular venue. Embedding the content may include adding the QR code to a frame around other content (e.g., included in an info bar below videos displayed at the streaming device 106), superimposed over other content, or as part of an advertisement or interstitial display between other content segments. Devices that scan the QR code (or otherwise interact with the actionable content) may be directed to a web address, web app, or mobile application that supports the upload, editing, and captioning of a photo, video, or other content from the user's device 104. As an example, the custom web application may include a NestJS application deployed to Amazon Web Services (AWS)® with a PostGRES® SQL DB. The dynamic UGC module 110 may store the uploaded UGC to DB 116 as user content 118. The user may be prompted to select a timespan to display their content, provide payment, select other venue options, or otherwise finalize the dynamic user content display request. For example, the venue-specific QR code may automatically direct the dynamic UGC module 110 to select the venue at which the QR code was displayed as the location to display the user's shout-out. However, a user may have the option to select other venues (e.g., specific addresses), geographical regions, types of venue (e.g., bars, or a particular restaurant chain), or any combination. In some examples, a user may select to have their shout-out follow the user's device via GPS location or other tracking mechanism, so if the user is moving from venue to venue, their content may be displayed at any participating streaming device 106 associated with streaming service 102.

Raw images or videos may be uploaded to the streaming service 102 servers along with added text captions, audio clips, or other special effects (e.g., sparkle or confetti animations). The dynamic UGC module 110 may perform moderation on uploaded UGC images, text, or other content to ensure no objectionable content is displayed to venue patrons. In some examples, the dynamic UGC module 110 may initially post uploaded UGC elements to a private channel for human moderators to review and approve before it will be distributed. The dynamic UGC module 110 may be configured to perform image, text, or vocal recognition software to detect objectionable images or phrases in UGC. In some examples a combination of moderation approaches may be used, such as an initial automated evaluation, followed by a manual evaluation of any UGC that passes the automated evaluation. Optionally, no moderation may be performed.

The dynamic UGC module 110 may use video or graphic software such as AWS Elemental MediaTailor® to dynamically create a venue-specific QR code, image of text for the caption, and overlay these onto a custom background for the UGC to rasterize a final dynamic user content element for display, which may be called a shout-out. The shout-out creative may then be trafficked via the streaming service 102 serving platform at the appropriate times to streaming devices 106, or an intermediary such as a continuous delivery ad proxy, for display at appropriate points in a content stream. The shout-out creatives may be paced out in the context of other advertisements at individual streaming devices 106 at a time of an ad request or ad break. The pacing out of shout-outs may be handled by the streaming service 102 itself (e.g., via dynamic UGC module 110), by an intermediary service (such as an advertising proxy), or by a streaming device 106 (e.g., via UGC display module 120).

Streaming device 106 may comprise a device such as a television, set top box, or other device that streams content for display, such as over the top (OTT) media streamed via network 108 (e.g., the internet) from streaming service 102. In some examples, streaming devices 106 may include Android TV® or tvOS® streaming televisions.

Streaming device 106 may be configured to tune to one or more streaming channels by making a connection to streaming service 102, where channels may have different programming content, such as video clips, news tickers or other informational frames, advertising, and other elements. In some examples, streaming device 106 may be displayed at a public venue, such as a bar, restaurant, or other shopping or entertainment venue. The streaming device 106 may present an invitation to upload or submit UGC for display at the venue, along with a QR code, web address, passcode, or other actionable element that viewers can use to connect a user device 104 to streaming service 102 and submit content. Streaming device 106 may include a UGC display module 120 and a display 122.

UGC display module 120 for streaming device 106 may perform operations associated with displaying actionable content such as QR codes to enable users to upload UGC, and operations to display UGC along with streaming content from streaming service 102. In some examples, UGC display module 120 may correspond to dynamic UGC module 110 of streaming service 110, and may perform some of the operations described in regards thereto. UGC display module 120 may receive a venue-specific QR code or other actionable element from streaming service 102, and may display it via display 122. The QR code may be received pre-included or embedded in a content stream, or it may be received as a separate file or data element, and be displayed with, embedded in, or superimposed on a content stream by streaming device 106. In some examples, UGC display module 120 may generate a venue-specific QR code or actionable element itself, for example using a unique identifier (UID) of streaming device 106, or other venue-specific information stored at streaming device 106, along with a web link or address for a streaming service 102 for uploading or submitting UGC. Once UGC has been uploaded, the UGC display module 120 may be configured to display it as part of a content stream. In some examples, the UGC may be pre-inserted into a content stream received from streaming service 102 or another content source. In another example, streaming service 102 may provide the streaming device 106 with the UGC as a separate video segment, image, or graphic, and the UGC display module 120 may be configured to insert the UGC into a separate content stream at an appropriate position. The UGC may be received along with a timestamp at which the UGC should be displayed, or the UGC display module 120 may insert some number of shout-outs at selected intervals or during scheduled ad breaks in the streaming content.

Display 122 may include a combination of physical display components such as a television screen or monitor, and graphical elements such as streaming video, overlays such as news tickers, informational or decorative boarder elements, QR or other scannable overlays or additions, graphical or animation additions, or other visual or audio elements. In some embodiments, display 122 may be configured to receive user inputs, such as touch screen controls, remote control signals, or other inputs for streaming device 106. The display 122 may work in conjunction with UGC display module 120 to display content streams and dynamic user-generated content uploads.

User device 104 may comprise a network 108—connected computing device used to upload user-generated content. For example, user device 104 may include a smart phone, tablet, laptop device, desktop computer or PC, kiosk, set top box, or other computing device that may use actionable content to access a web interface for streaming service 102 and upload and customize user content for display via streaming device 106. In an example, user devices 104 (e.g., iOS or Android® smartphones) may include a camera element and software configured to scan a QR code, and obtain data from it such as a web address. The QR code may direct the user device 104 to open a mobile app for uploading UGC to the streaming service 102, or may enable the user device 104 to follow a link using a web browser app to access a web app for uploading UGC to the streaming service 102. Accordingly, user device 104 may include a user interface (UI) element 112, and a UGC creation module 114.

User interface 112 may include user input elements of the user device 104 (e.g., touch screen, keyboard, pointer device, or other physical input components), as well as a graphical user interface (GUI) showing a user the UGC upload and customization interface for the streaming service 102 and dynamic UGC module 110.

For example, the UGC uploading app or service may provide a UI 112 for allowing a user to select a file (e.g., a picture of video) to upload from the user device 104 to the streaming service 102. The UI 112 may also allow a user to enter text, add graphical effects, add sound effects or music files, or otherwise customize the uploaded file as a UGC data element (which may be stored by the streaming service 102 as user content 118). The UI 112 may also enable a user to select a time or timeframe to display the UGC, select a current venue at which the user scanned the QR code or another venue(s) at which to display the UGC, enter payment information, or otherwise complete the transaction. As an example, a viewer of a sporting event at one venue may choose to display a message at another venue associated with a losing team saying, “better luck next time!”. User interface 112 may work in conjunction with UGC creation module 114 to enable uploading and customizing UGC for display via steaming service 102 and streaming device 106.

UGC creation module 114 may include an app or other program including executable instructions for uploading or generating UGC 118 to streaming service 102 via network 108 (e.g., via internet or mobile network communications). For example UGC creation module 114 may be a local app of user device 104, or a web app accessed through an internet browser of user device 104. The UGC creation module 114 may include the instructions for generating the GUI elements of User Interface 112, as well as instructions for accessing user files for uploading, and generating and sending data packets over network 108 to streaming service 108.

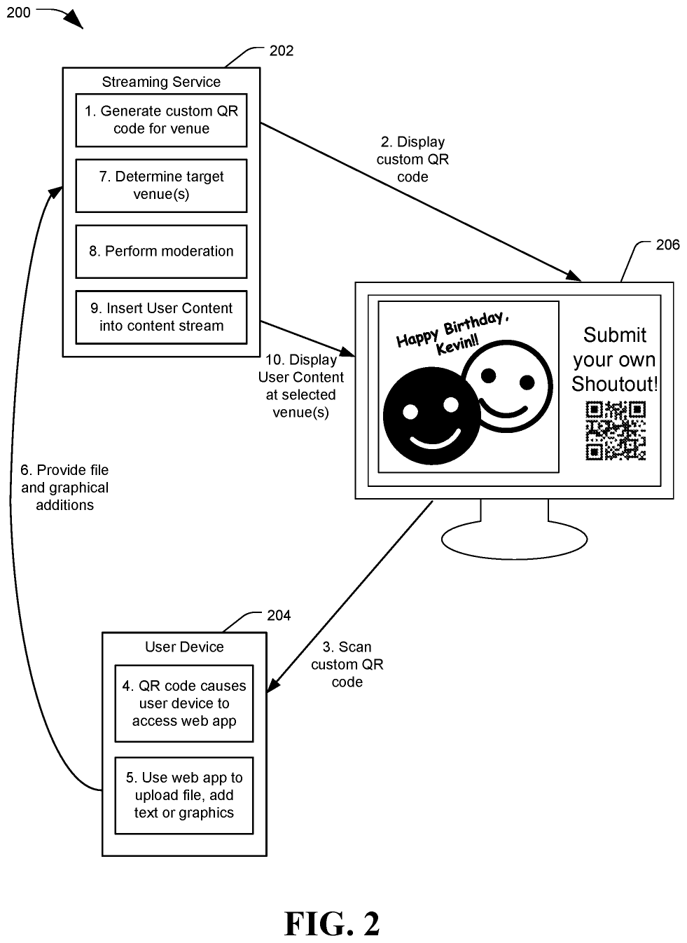

The streaming system 100 of FIG. 1 enables a user or venue-goer to be able to reach a wide audience, either in the immediate venue or at venues of the user's choosing, with their own UGC in near-real time (e.g., in a matter of seconds or minutes). For example, a user may upload a picture of their friend for the friend's birthday at a restaurant or bar they are attending, so that everyone in the venue can recognize the friend and wish them happy birthday. A user may upload a wedding proposal video for their fiancé to perform a romantic and public gesture. A user who has an online video channel may promote their channel to a crowded pub. The dynamic display of user content afforded by the proposed streaming system 100 may enable unprecedented levels of creating awareness, self-promotion, or enabling social gestures. The system 200 addresses a problem of reaching wide viewership without significant financial investment or growing an audience ahead of time, and this functionality can be performed on-the-fly without time-consuming planning or negotiation. Another example system for dynamic display of user content is depicted in regard to FIG. 2.

FIG. 2 depicts a diagram of a system 200 configured to implement a dynamic display of user content, in accordance with certain embodiments of the present disclosure. In particular, FIG. 2 presents an operational flow of an example embodiment of a content streaming system configured to dynamically display uploaded user content via streaming devices in public venues, as described herein. System 200 may include a streaming service 202, a user device 204, and a streaming device 206, which may correspond to streaming service 102, user device 104, and streaming device 106 of FIG. 1.

At step 1, the streaming service 202 may generate a custom or venue-specific QR code (or other actionable element) which can be used to submit user generated content (UGC) for display. The QR code may include data identifying a particular streaming device 206 (e.g., by device ID or other identifier), a particular venue (e.g., by a venue ID assigned by the streaming service 202, by a geographical location, by address, by venue name, or via some other identifier). The QR code may also include a web address or link directing a scanning device to a web app for uploading UGC, or to a download page for a mobile application that can be used to upload UGC. The link or web address may include the venue-specific information, or the QR code may direct the scanning device to submit the venue-specific information, so that the target network address knows where the QR code was scanned.

The generated QR code may be inserted into a content stream and provided to the streaming device 206 for display, at step 2. In another embodiment, the streaming device 206 may generate the QR code, and insert it into or display it with streaming content from streaming service 202. The QR code may be displayed along with a call to action, such as an invitation to submit user content, or a “shoutout” for display.

At step 3, a user device 204 may scan the custom QR code, for example using a camera module included in the user device. The QR code may pull up a web link that a user can manually choose to follow, or it may automatically direct the user device 204 to access a web app, mobile application download site, or other web address via which a user can submit a picture, video clip, or other UGC to streaming service 202, at step 4.

At step 5, the user device 204 may utilize the web app and an associated graphical user interface (GUI) to select one or more files to upload, and potentially make embellishments such as adding text, adding graphical elements such as borders, filters, overlays like hats, glasses, or fireworks, add music or sound effects, or otherwise generate an enhanced shoutout or UGC element. The uploaded file and any added flourishes may be provided to the streaming service 202, at step 6.

At step 7, the streaming service 202 may determine a target venue for displaying the UGC. The target venue may be identified based on information from the custom QR code when it is scanned by user device 204, or included along with UGC provided from user device 204 to streaming service 202. In some embodiments, a user of user device 204 may select a target venue, such as through the GUI of the web app or mobile application used to submit the UGC. For example, in addition to or instead of the venue at which the QR code was scanned, a user may choose another specific venue, a geographical region (e.g., all participating venues within the region), select to have the UGC display follow the user (e.g., based on a GPS signal provided by the user device 204 to streaming service 202), or otherwise choose where to have the UGC display. In addition, a time frame for the UGC display, a duration of the display, a cost of the transaction, or other details may be determined or negotiated by streaming service 202.

Streaming service 202 may also perform moderation on the UGC, at step 8. For example, the streaming service 202 may send the UGC through an automated content filter, such as an image recognition module or service trained using machine learning to recognize objectionable visual or audio content. Instead of or in addition to an automated censor system, the streaming service 202 may also have the UGC checked by manual censors, such as by publishing the UGC to a moderation application viewed by human moderators. For example, the streaming service 202 may only have human moderators review UGC that passed the automated moderation, or was flagged by the automated moderation as objectionable or potentially objectionable.

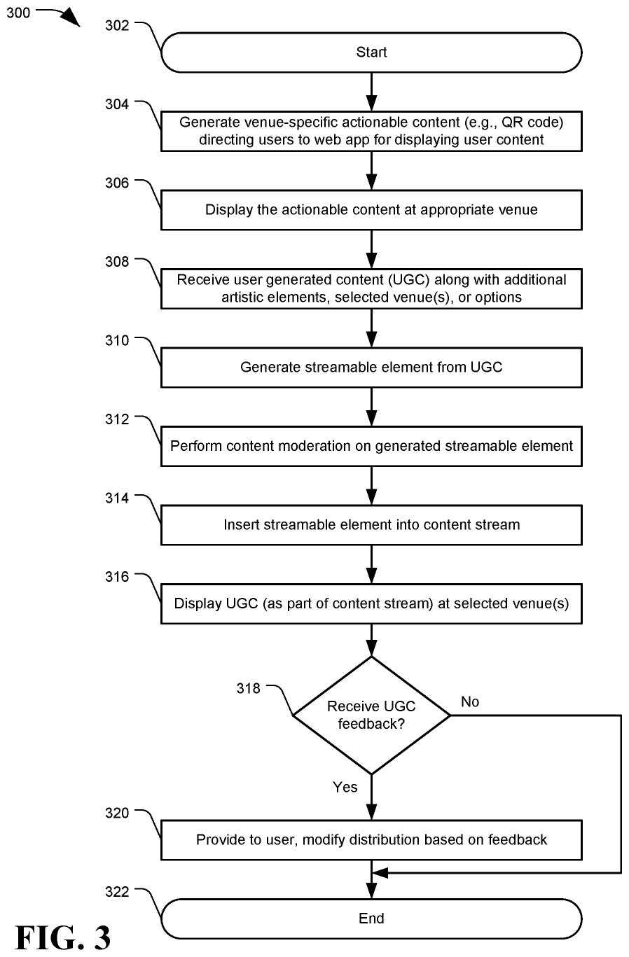

At step 9, the streaming service 202 may insert the UGC into a content stream provided to the target venue(s) or streaming device(s) 206. The UGC may be included as a full-screen image or video, or may be imposed over a background or border. A background or border may include elements such as text (added by the user for the UGC, or by the streaming service 202), or a venue-specific QR code inviting other users to submit shoutouts, or other elements. In some embodiments, each streaming device 206 has a customized content stream provided, and the streaming service 202 may insert or incorporate the UGC into the appropriate content streams before transmitting it to the streaming device 206. In other embodiments, the UGC may be prepared as a separate advertisement, segment, or slide, and provided to the target streaming device 206 as a separate data package or file from the streaming content, wherein the streaming device 206 may insert the UGC into an appropriate ad break or space in the streaming content. At step 10, the streaming service 202 and streaming device 206 may display the user content at the selected or target venues or streaming devices 206. FIG. 3 depicts an example method for performing dynamic display of user content.

FIG. 3 depicts a flowchart 300 of an example method for dynamic display of user content, in accordance with certain embodiments of the present disclosure. In particular, the method of FIG. 3 may be a process for displaying user generated content at public venues in near real-time, allowing users to reach wide audiences quickly and easily. The method of FIG. 3 may be implemented by systems shown in FIG. 1, such as streaming service 102, user device 104, and streaming device 106, or some combination thereof, generally collectively referred to as the streaming system 100.

The method may start at 302, and may include generating a venue-specific actionable content item (e.g., a QR code, bar code, web link, etc.) directing users to a web app or mobile application for sharing and displaying user content, at 304. At 306, the method may include displaying the actionable content at the appropriate venue, such as by including it in a content stream transmitted to the venue, or by providing it to the venue for insertion into a content stream at a streaming device of the venue. The QR code may be shown on a screen in a public venue space, such as a bar, restaurant, sporting event, or other venue, where users may be able to act on the actionable content to share their pictures or videos publicly. For example, users may scan the QR code to access a web app, select a file to share, add text or other embellishments, and submit the UGC to the streaming service.

At 308, the method may include receiving the UGC along with other artistic elements or embellishments, a selected venue (or an indication of the venue where the QR code was scanned) at which to display the content, or other options. The method may include generating a streamable element from the UGC, at 310. For example, the streaming service may combine the uploaded file (image or video) and any additional text or other elements, add a frame, or otherwise produce the shoutout or complete UGC that would be displayed at a venue. The UGC may be stored to a local database or server, and may be converted into a different format (e.g., an image may be converted into a video, potentially with added animated graphics), and prepared for insertion or display along with a streamed content feed or channel.

At 312, the method may include performing content moderation on the generated streamable element. Content moderation may include performing automated, manual, or combined or hybrid moderation techniques to prevent objectionable content from being displayed at the selected venue.

At 314, the method may include inserting the streamable element into a content stream. For example, a content stream or channel may be streamed over an internet or other network connection, and may include a sequence of video segments, such as new segments, sports clips or events, music videos, or other content, as well as ad breaks or other segment breaks into which the UGC streamable element may be inserted. The streamable element may be inserted at a streaming service prior to broadcast to the venue, or inserted at the venue by a streaming device, if the streamable element is provided to the streaming device separately from the content stream.

The method may include displaying the UGC streamable element, as part of or along with the content stream, at selected venues, at 316. In an example embodiment, the UGC is displayed at the same venue where actionable content or QR code was engaged with. In another example, a user may be able to specify other or additional venues at which to display the UGC. The UGC may be shown on streaming device screens publicly displayed at the venue, which may include multiple streaming devices within a single venue. In some examples, the UGC may be displayed along with other actionable content, such as a QR code for other users to submit their own content, or a QR code to provide feedback on the currently displayed UGC.

At 318, a determination may be made whether UGC feedback has been received. For example, a QR code or other actionable content displayed with the UGC may direct scanning devices to a web app or website where the users can rate the UGC (e.g., based on a 5-star rating system, thumbs-up or thumbs-down review, etc.), provide comments, or report a UGC as including objectionable content. A streaming service may monitor for any feedback that is received and associated with a particular UGC.

If feedback is received, at 318, the method may include providing the feedback to the user, modifying distribution of the UGC based on the feedback, or taking other steps. For example, a user that has uploaded UGC may be able to look up comments and reviews that viewers have submitted. Further, a UGC may be displayed multiple times or at multiple venues. If a UGC reviews well, it may be displayed more frequently or more widely. If a UGC reviews poorly or is reported for objectionable content, it may be reviewed by moderators, distributed less frequently or less widely, or removed from further display.

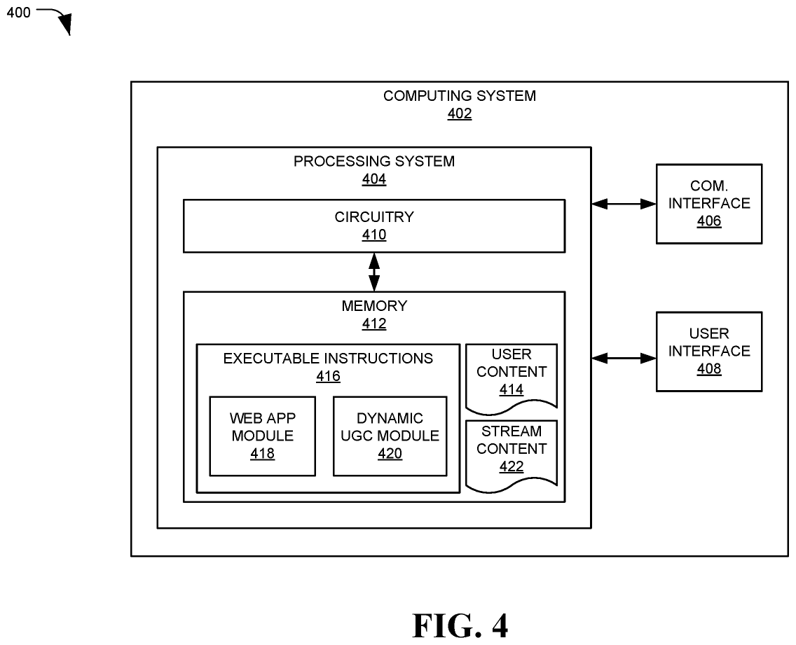

Once the feedback has been managed, or if no feedback is received, then the method may end, at 322. An example system for implementing dynamic display of user content is described in regard to FIG. 4.

FIG. 4 is a diagram of a system 400 configured to implement a dynamic display of user content, in accordance with certain embodiments of the present disclosure. In particular, FIG. 4 depicts a computer system 402, which may be an example of any computing system that may be employed to perform the operations of trivia synchronizer 102, user device 104, streaming device 106, and related processes and methods. Computing system 402 may include a processing system 404, a communication interface 406, and a user interface 408. Computing system 402 may include other components, such as a battery and enclosure, that are not shown for clarity. Computing system 402 may comprise one or more server computing systems, desktop computing systems, laptop computing systems, smartphone devices, set-top or streaming boxes, connected televisions, or any other computing system, including combinations thereof.

Communication interface 406 may comprise components that communicate over communication links, such as network cards, ports, radio frequency (RF), processing circuitry and software, or other communication components. Communication interface 406 may be configured to communicate over metallic, wireless, or optical links. Communication interface 406 may be configured to use Time Division Multiplex (TDM), Internet Protocol (IP), Ethernet, optical networking, wireless protocols, communication signaling, other communication formats, or any combinations thereof. Communication interface 406 may also enable communication with local external devices, such as external storage or interface devices.

User interface 408 may comprise components that interact with a user to receive user inputs and to present media or other information. User interface 408 may include a display screen, touch screen, touch pad, keyboard, buttons, speaker, microphone, pointer device or interface, communication port, other user input/output apparatus, or any combination thereof. User interface 408 may also include a camera or image capture apparatus for scanning elements such as QR codes. In some examples, user interface 408 may be a module configured to interface with a separate system for presenting information and receiving inputs. For example, computing system 402 may have limited or no direct user input components, but it connects (e.g., via communication interface 406) to a monitor or other device that may receive inputs via touch screen, remote control, or other input method, which inputs are then provided or relayed to computing system 402.

Processing system 404 may be linked to communication interface 406 and user interface 408. Processing system 404 can include processing circuitry 410 and memory device 412. Memory device 412 can store executable instructions or other operating software 416, as well as non-executable data files, such as user content 414, and stream content 422. User content 414 may include files uploaded by users, such as pictures, videos, or audio, and may also include added embellishments such as text, music or sound effects, added graphical elements, borders, or other elements that together may comprise a UGC displayed at public venues. User content 414 may also include details about user profiles and accounts, billing information, transaction histories, preferences and settings, or other user-specific details. Stream content 422 may include video segments or combined streamable files, details about different streams or channels, content and advertising schedules, access or routing details for content providers for streaming content, or other information associated with streaming content.

Processing circuitry 410 may comprise a microprocessor and other circuitry that can retrieve and execute instructions 416 from memory device 412. Memory device 412 may comprise a non-volatile data storage medium, such as a disk drive or solid state drive, or volatile memory such as random access memories (RAM) and dynamic RAM (DRAM), or any other memory apparatus. In some examples, processing circuitry 410 may be mounted on a circuit board that may also hold memory device 412 and portions of communication interface 406 or user interface 408.

Executable instructions 416 may comprise computer programs, firmware, or some other form of machine-readable processing instructions. Executable instructions 416 may include web app module 418, and dynamic UGC module 420, although related operations may be handled by multiple different modules or programs (potentially located on multiple computing devices), all operations may be performed by a single module, or additional modules may be included in executable instructions 416. For example, elements or aspects of web app module 418 and dynamic UGC module 420 may be implemented by streaming service 102, user device 104, streaming device 106, other systems, or a combination thereof. Executable instructions 416 may further include an operating system, utilities, drivers, network interfaces, applications, or other types of software. When executed by processing circuitry 410, executable instructions 416 may direct processing system 404 to operate computing system 402 as described herein.

Web app module 418 may be a set of instructions for providing a graphical user interface (GUI) by which users may select files for uploading, modify or embellish the files, select various graphical or auditory options, select venues, select display time periods, duration, or frequency, enter payment information, or otherwise utilize the dynamic user content display services. The web app module 418 may be executed server-side, client-side, or a combination thereof. The web app module 418 may take the form of a downloadable mobile application that users can download and execute at their mobile devices.

Dynamic UGC module 420 may include a set of computer functions or instructions for managing UGC received from users, determining appropriate venues for display, performing content moderation, determining display times and durations, format conversion for display in a content stream, and inserting the UGC into the content stream at an appropriate point for the selected venue.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
implementing a system to dynamically display user content, including:
displaying, via a streaming service, an actionable content element at a display of a first public venue, the actionable content element directing a user device to a service for uploading user generated content (UGC);
receiving the UGC at the streaming service; and
displaying the UGC at a screen of a selected public venue.

2. The method of claim 1 further comprising the actionable content element includes a quick response (QR) code.

3. The method of claim 1 further comprising:
generating the actionable content element to include venue-specific data identifying the first public venue; and
receiving the venue-specific data along with the UGC at the streaming service.

4. The method of claim 3 further comprising:
setting the selected public venue to include the first public venue based on receiving the venue-specific data.

5. The method of claim 1 further comprising:
receiving a venue selection input from the user device along with the UGC at the streaming service; and
setting the selected public venue to include a second public venue identified by the venue selection input.

6. The method of claim 1 further comprising:
performing, at the streaming service, content moderation on the UGC to prevent display of objectionable content.

7. The method of claim 6 further comprising the content moderation includes evaluating the UGC using an automated content filter.

8. The method of claim 1 further comprising the UGC includes at least one of an image file and a video file.

9. The method of claim 1 further comprising:
providing, via the streaming service, the service for uploading the UGC, including a web application;
providing functionality to augment the UGC with additional artistic elements to create an augmented UGC; and
displaying the augmented UGC at the selected public venue.

10. The method of claim 1 further comprising:
generating a scannable code enabling a scanning device to provide feedback on the UGC;
including the scannable code along with the UGC when displaying the UGC at the screen of the selected public venue;
receiving the feedback on the UGC at the streaming service; and
providing the feedback to a user that uploaded the UGC.

11. A system comprising:
a streaming service configured to dynamically display user content, including:
display an actionable content element at a display of a first public venue, the actionable content element directing a user device to a service for uploading user generated content (UGC);
receive the UGC at the streaming service; and
display the UGC at a screen of a selected public venue.

12. The system of claim 11 further configured to:
generate the actionable content element as a quick response (QR) code;
generate the QR code to include venue-specific data identifying the first public venue;
receive the venue-specific data along with the UGC at the streaming service; and
set the selected public venue to include the first public venue based on receiving the venue-specific data.

13. The system of claim 11 further configured to:
receive a venue selection input from the user device along with the UGC at the streaming service; and
set the selected public venue to include a second public venue identified by the venue selection input.

14. The system of claim 11 further configured to:
receive the UGC as at least one of an image file and a video file; and
perform automated content moderation on the UGC using an automated content filter to prevent display of objectionable content.

15. The system of claim 11 further configured to:
provide the service for uploading the UGC, including a web application;
provide functionality to augment the UGC with additional artistic elements to create an augmented UGC; and
display the augmented UGC at the selected public venue.

16. The system of claim 11 further configured to:
generate a scannable code enabling a scanning device to provide feedback on the UGC;
include the scannable code along with the UGC when displaying the UGC at the screen of the selected public venue;
receive the feedback on the UGC at the streaming service; and
provide the feedback to a user that uploaded the UGC.

17. A memory device storing instructions that, when executed, cause a processor to perform a method comprising:
implementing a system to dynamically display user content, including:
generating, via a streaming service, a quick response (QR) code that includes venue-specific data identifying a first public venue;
displaying, via the streaming service, the QR code at a display of the first public venue, the QR code directing a user device to a service for uploading user generated content (UGC), the UGC including at least one of an image file and a video file;
receiving the UGC and the venue-specific data at the streaming service;
setting a selected public venue to include the first public venue based on receiving the venue-specific data; and
displaying the UGC at a screen of the selected public venue.

18. The memory device of claim 17 storing instructions that, when executed, cause the processor to perform the method further comprising:
performing, at the streaming service, automated content moderation using an automated content filter on the UGC to prevent display of objectionable content.

19. The memory device of claim 17 storing instructions that, when executed, cause the processor to perform the method further comprising:
providing, via the streaming service, the service for uploading the UGC, including a web application;
providing functionality to augment the UGC with additional artistic elements to create an augmented UGC; and
displaying the augmented UGC at the selected public venue.

20. The memory device of claim 17 storing instructions that, when executed, cause the processor to perform the method further comprising:
generating a scannable code enabling a scanning device to provide feedback on the UGC;
including the scannable code along with the UGC when displaying the UGC at the screen of the selected public venue;
receiving the feedback on the UGC at the streaming service; and
providing the feedback to a user that uploaded the UGC.
